(19) United States
(12) Patent Application Publication
(10) Pub. No.: US 2013/0097261 A1
(43) Pub. Date: Apr. 18, 2013

(54) SAFE AND MONITORED VIRTUAL WORLD

(71) Applicants: Howard R. Baer, Scottsdale, AZ (US); Michael Blum, Phoenix, AZ (US); Tim Dedecker, Glendale, AZ (US); Richard Doctor, Phoenix, AZ (US)

(72) Inventors: Howard R. Baer, Scottsdale, AZ (US); Michael Blum, Phoenix, AZ (US); Tim Dedecker, Glendale, AZ (US); Richard Doctor, Phoenix, AZ (US)

(21) Appl. No.: 13/652,173

(22) Filed: Oct. 15, 2012

Related U.S. Application Data
(60) Provisional application No. 61/546,970, filed on Oct. 13, 2011.

(51) Int. Cl. G06F 15/16

(52) U.S. Cl. 709/206

(57) ABSTRACT

The present invention relates to a system and method for safe electronic communication for children. According to one exemplary embodiment, the present invention provides a virtual world with avatars and online social interaction for children that is monitored by a parent or other guardian. In one embodiment, children may complete certain tasks for points that can be redeemed for certain awards. These tasks may include caring for a virtual pet that would allow the child to earn points to adopt a real pet from a pet store or humane society.

### CROSS-REFERENCE TO RELATED APPLICATION

This application claims priority to and the benefit of U.S. Provisional Patent Application No. 61/546,970 filed on Oct. 13, 2011 entitled “Safe and Monitored Virtual World,” wherein such provisional application is hereby incorporated in its entirety.

### FIELD OF INVENTION

The present invention generally relates to providing a safe and controlled online virtual world for children to participate in virtual role playing, interactive activities and communication such as audio and video communication, texting and e-mail, and for providing a virtual currency and/or points redemption program for children

### BACKGROUND

The internet has revolutionized the way that people communicate. The speed and convenience provided by internet enabled interaction and communication is an undeniable benefit. However, ease of access and interaction has become a security concern for many parents. Further, embracing the openness internet enabled technologies has often led to uncontrolled and unmonitored sites and experiences online that may be unsuitable for children. Much of the functionality enabled by online portals, games and virtual worlds is directed toward business and/or adult users. Children being contacted, influenced, manipulated and worse by unwanted, unwelcomed and often dangerous online predators is a primary concern for many parents today. At the same time, many parents would like their child to learn communication tools and enjoy the benefits of internet enabled educations, entertainment and social interaction.

Thus, a long-felt need exists to provide a robust, rules driven, sophisticated and customizable virtual world and interaction (e.g., communication) interface to enable children to participate in a virtual world in a controlled, monitored and safe manner.

There is also a need for the virtual world to include a task or activity assignment and scheduling system to allow one user, such as a parent, to define and schedule certain tasks and appointments for a second user, such as a child. It would be advantageous if this rewards program also enabled the parent to award points to a child for completing certain tasks or activities. It would also be beneficial for those points to be redeemable by the child in the virtual world and/or at real-life merchants.

### SUMMARY OF THE INVENTION

The present invention provides a virtual online world (or environment) as described in various exemplary embodiments disclosed herein. In one embodiment, the system of the present invention is configured to allow a parent or other third party to approve only certain select people, or virtual representations of or associations with (e.g., avatars) such select people or other entities (e.g., virtual organizations or businesses), with which a child can initiate and/or accept interaction in the online world. For example, the system enables a parent to review and approve a request for their child's online character (i.e. avatar) to become a friend with another online avatar. In one exemplary embodiment, the present invention is configured to monitor the content of various interactions in the virtual world such as chat, video chat, video communications, e-mails, text messages (including photographs sent with text messages), and messages as well a virtual commerce transactions. The system enables flagging, tracking, reporting on, enabling, disabling and intervening with various interactions that may contain objectionable content or be associated with objectionable activity. Objectionable activity may be defined by system rules or algorithms as well as user defined rules, parameters, examples and algorithms. For example, a video communication may be disabled if the system determines that a certain threshold of flesh or flesh related video is being transmitted to prevent so-called “sexting” from occurring.

In another exemplary embodiment, the system of the present invention is configured to allow a parent or other third party to assign tasks and create calendars thr children or another third party designee. In an embodiment, a portal enables a reward system whereby, for example, a child may earn points for completing a task and may redeem the points in a variety of ways. In one such embodiment, a child may receive points for caring for a virtual pet and may exchange those points for a real animal at a pet store or humane society. Further, in another exemplary embodiment, the present invention is configured to monitor the content of various social networking interaction enabled by the portal.

In another exemplary embodiment, based upon configurable rules, communications containing objectionable content are intercepted, disabled and/or routed to a parent or other third party for approval before sending them to a child.

### BRIEF DESCRIPTION OF THE DRAWINGS

A more complete understanding of the present inventions may be derived by referring to the detailed description and claims when considered in connection with the Figures, wherein like reference numbers refer to similar elements throughout the Figures, and:

FIG. 1 is a block diagram illustrating major system components for a safe online environment, in accordance with an embodiment of the present invention;

FIG. 2 is a process flow chart showing a process for monitoring and filtering email, in accordance with an embodiment of the present invention;

FIG. 3 is an interface diagram illustrating a user dashboard, in accordance with an embodiment of the present invention;

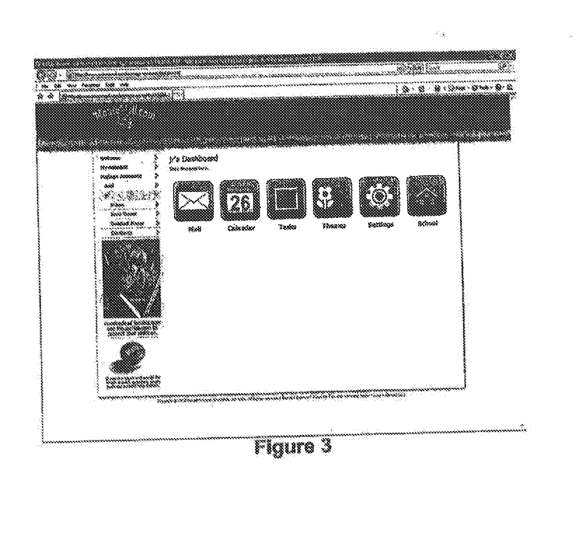

FIG. 4 is an interface diagram illustrating a parent review interface, in accordance with an embodiment of the present invention;

FIG. 5 is an interface diagram illustrating a parent review interface, in accordance with an embodiment of the present invention;

FIG. 6 is an interface diagram illustrating a confirmation message, in accordance with an embodiment of the present invention;

FIG. 7 is a block diagram illustrating major system components for a safe online environment, in accordance with an embodiment of the present invention;

FIG. 8 is a process flow chart showing a process for monitoring and filtering email, in accordance with an embodiment of the present invention;

FIG. 9 is a process flow chart showing a process for assigning tasks, in accordance with an embodiment of the present invention;

FIG. 10 is an interface diagram illustrating a user dashboard on the portal, in accordance with an embodiment of the present invention;

FIG. 11 is an interface diagram illustrating a task interface on the portal, in accordance with an embodiment of the present invention;

FIG. 12 is an interface diagram illustrating a calendar interface on the portal, in accordance with an embodiment of the present invention;

FIG. 13 is an interface diagram illustrating a question and point aware on the portal, in accordance with an exemplary embodiment of the present invention.

FIG. 14 is a block diagram illustrating major system components for a safe online environment, in accordance with an embodiment of the present invention;

FIG. 15 is a process flow chart showing a process for monitoring and filtering messages, in accordance with an embodiment of the present invention;

FIG. 16 is an interface diagram illustrating a user dashboard, in accordance with an embodiment of the present invention;

FIG. 17 is an interface diagram illustrating a parent review interface, in accordance with an embodiment of the present invention;

FIG. 18 is an interface diagram illustrating a parent review interface, in accordance with an embodiment of the present invention;

FIG. 19 is an interface diagram illustrating a confirmation message, in accordance with an embodiment of the present invention; and

FIG. 20 is a process flow chart showing a process for monitoring and filtering text messages and e-mail, in accordance with an embodiment of the present invention.

### DETAILED DESCRIPTION OF EXEMPLARY EMBODIMENTS

The present invention fundamentally changes the way children interact in virtual online environments. The invention improves upon existing systems by providing a tangible, integrated, safe online or virtual world system (hereinafter a “Safe World”). The invention may be implemented by a system or a method or any combination of systems and methods. The Safe World may included a safe messaging monitoring system (“SMMS”) that may allow a first avatar (e.g., a parent) control access to and monitor communications with a second avatar (e.g., a child). In one embodiment, SMMS enables text, audio and/or video interaction in a safe and monitored environment. Although an online portal interface is often used to illustrate the functionality enabled by SMMS, one skilled in the art will recognize that, in various embodiments, both the functions and the interface may vary to provide enhanced features or functionality. For example, SMMS functionality may be enabled on a mobile device, such as a cell phone. In one embodiment, SMMS functionality enables messaging, communication (e.g. video communication) and data sharing aspects of a social network or online community. For instance, a parent (or other authorized person) may provide approval for contacts/friends who may interact with a child in a virtual world and/or on a social network and message content analysis may be used to monitor, flag, filter or delete content that the social network (or one of it's members) finds objectionable. In one embodiment, the system described herein can be incorporated within or used in conjunction with the functionality described in co-pending applications: U.S. Patent Application No. 61/506,587 filed on Jul. 11, 2011 and entitled “E-Mail, Text, And Message Monitoring System And Method”; U.S. Patent Application No. 61/350,418, filed on Jun. 1, 2010 and entitled “Text Message Monitoring System”; and U.S. Patent Application No. 61/330,213 filed on Apr. 30, 2010 and entitled “Calendaring and Points System”; each of which are incorporated by reference in their entireties.

While the embodiments described herein are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, SMMS includes a user interface (UI), a software module, logic engines, numerous databases and computer networks. While SMMS may contemplate upgrades or reconfigurations of existing processing systems, changes to existing databases and system tools are not necessarily required by the present invention.

The benefits provided by this invention include, for example, increased security, monitoring, usability, functionality, comfort, familiarity and efficiency in online interactions and online enabled communications. For example, children benefit from a monitored and/or controlled virtual world environment to communicate with “safe” entities while learning valuable computer and online communications skills. Parents benefit from the assurance of multi-level safeguards against unwanted and potentially dangerous contact with their children while still enabling their children an aspect of freedom to use and learn via a virtual online experience.

While the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, camera or video enabled (e.g. motion detection) input devices, kiosks and handheld devices such as mobile phones, smart phones, tablet computing devices, etc.

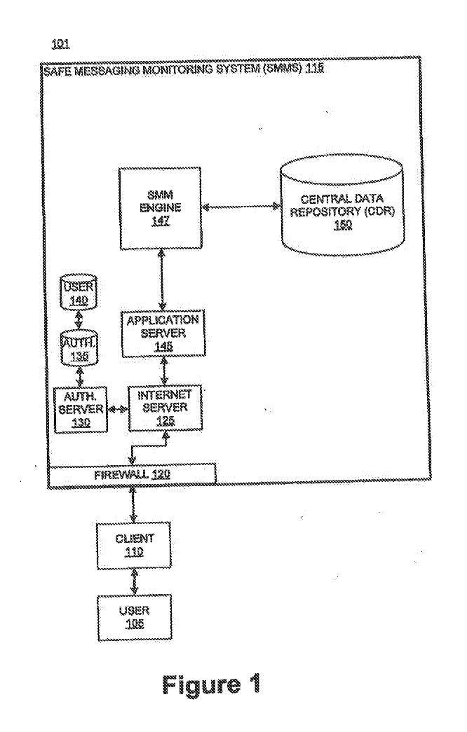

A “user” may include any individual, entity, software and/or hardware that interacts with a system and/or participates in a process. With reference to FIG. 1, user 105 may perform tasks such as initiating a communication, receiving a communication, and requesting, retrieving, receiving, updating, analyzing and/or modifying data. User 105 may interface with Internet server 125 via any communication protocol, device or method discussed herein, known in the art, or later developed. User 105 may be, for example, a parent, a child, teacher, a friend, a classmate, a coach, or a system administrator.

In one embodiment, with reference to FIG. 1, system 101 includes a user 105 interfacing with a SMMS 115 by way of a client 110. SMMS 115 is a fully integrated system comprised of various subsystems, modules and databases. Client 110 comprises any hardware and/or software suitably configured to facilitate entering, accessing, requesting, retrieving, updating, analyzing, entering and/or modifying data. The data may include communication data (e.g. email, audio, video, text, graphics, files, etc), verification data, authentication data, instructional data, demographic data, transaction data, or any information discussed herein.

Client 110 includes any device (e.g., personal computer), which communicates (in any manner discussed herein) with the SMMS 115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, tablets, kiosks, and/or the like. Practitioners will appreciate that the client 110 may or may not be in direct contact with the SMMS 115. For example, the client 110 may access the services of the SMMS 115 through another server, which may have a direct or indirect connection to Internet server 125.

User 105 may communicate with the SMMS 115 through a firewall 120 to help ensure the integrity of the SMMS 115 components. Internet server 125 may include any hardware and/or software suitably configured to facilitate communications between the client 110 and one or more SMMS 115 components.

Firewall 120, as used herein, may comprise any hardware and/or software suitably configured to protect SMMS 115 components from users of other networks. Firewall 120 may reside in varying configurations including stateful inspection, proxy based and packet filtering, among others. Firewall 120 may be integrated as software within Internet server 125, any other system 101 component, or may reside within another computing device or may take the form of a standalone hardware component.

Authentication server 130 may include any hardware and/or software suitably configured to receive authentication credentials, encrypt and decrypt credentials, authenticate credentials, and/or grant access rights according to pre-defined privileges associated with the credentials. Authentication server 130 may grant varying degrees of application and data level access to users based on information stored within authentication database 135 and user database 140. Application server 145 may include any hardware and/or software suitably configured to serve applications and data to a connected client 110.

According to one embodiment, SMMS 115 is used to manage and integrate messaging portal, and message monitoring and routing capabilities. SMMS 115 is a fully integrated system comprised of various subsystems, modules and databases. With reference again to FIG. 1, SMMS 115 allows communication with a central data repository (“CDR”) 150 and various other portals and UIs (not shown in FIG. 1) in one embodiment, UIs are accessed via a web portal to send and receive email messages, text messages (e.g., short message service (SMS)), multimedia messaging service (MMS) messages and the like. SMMS 115 components are interconnected and communicate with one another to allow for a completely integrated online messaging portal that allows users, for example, to send and receive email communications, approve/disapprove contacts for a child, approve/disapprove messaging content, etc.

Safe message monitoring engine (“SMM Engine”) 147 is a software module configured to enable online functions such as sending and receiving online communications, receiving query requests, configuring responses, dynamically configuring user interfaces, requesting data, receiving data, displaying data, streaming audio and/or video data, prompting user 105 with security challenges, verifying user responses, authenticating the user, initiating SMMS 115 processes, initiating other software modules, encrypting and decrypting. Additionally, SMM Engine 147 may include any hardware and/or software suitably configured to receive requests from client 110 via Internet server 125 and the application server 145. SMM Engine 147 is further configured to process requests, execute transactions, store or buffer video data, filter video data, construct database queries, and/or execute queries against databases, within system 101 (e.g., central data repository (“CDR”) 150), external data sources and temporary databases. In one embodiment, SMM Engine 147 is configured to execute application programming interfaces in order to communicate with a variety of messaging platforms such as, for instance, video communication systems, social networks, email systems, wireless communications systems, mobile communications systems, MMS systems, SMS systems and the like. For example, its one embodiment, SMM Engine 147 is configured to interface with any video communication software or protocol known in the art.

SMM Engine 147 is configured to exchange data with other systems and application modules. In one embodiment, SMM Engine 147 may be configured to interact with other system 101 components to perform complex calculations, retrieve additional data, format data into reports, create XML representations of data, construct markup language documents, construct, define or control UIs, and/or the like. Moreover SMM Engine 147 may reside as a standalone system or may be incorporated with the application server 145 or any other SMMS 115 component as program code. As one of ordinary skill in the art will appreciate, SMM Engine 147 may be logically or physically divided into various subcomponents such as a workflow engine configured to evaluate predefined rules and to automate processes associated with a messaging system and/or social network in SMMS 115.

in addition to the components described above, SMMS 115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Client 110 may include an operating system (e.g., Windows XP, Windows NT, 95/98/2000, XP, Windows 7, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In an embodiment, access is through a network or the Internet through a commercially available web-browser software package. Client 110 and SMMS 115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 110 and/or any of the system components may include wired and/or wireless portions.

Internet server 125 may be configured to transmit data to client 110 within markup language documents, “Data” may include encompassing information such as commands, messages, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (ITS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, application server 145 may communicate with any number of other servers, databases and/or components through any means known in the art. Further, application server 145 may serve as a conduit between client 110 and the various systems and components of SMMS 115. Internet server 125 may interface with application server 145 through any means known in the art including a LAN/WAN, for example. Application server 145 may further invoke software modules such as the SMM Engine 147, automatically or in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an internet protocol (“IP”) address, The web server retrieves the appropriate web pages and sends the data or applications for the web pages to the IP address, Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 1 depicts databases that are included in an exemplary embodiment of the invention. An exemplary list of various databases used herein includes: an authentication database 135, a user database 140, CDR 150 and/or other databases that aid in the functioning of the system. As practitioners will appreciate, while depicted as separate and/or independent entities for the purposes of illustration, databases residing within system 101 may represent multiple hardware, software, database, data structure and networking components. Furthermore, embodiments are not limited to the exemplary databases described herein, nor do embodiments necessarily utilize each of the disclosed exemplary databases.

Authentication database 135 may store information used in the authentication process such as, for example, user identifiers, passwords, access privileges, user preferences, user statistics, and the like. User database 140 maintains user information and credentials for SMMS 115 users (e.g., user 105).

CDR 150 is a data repository that is configured to store a wide variety of comprehensive data for SMMS 115. While depicted as a single logical entity in FIG. 1, those of skill in the art will appreciate that CDR 150 may, in some embodiments, consist of multiple physical and/or logical data sources. In one embodiment, CDR 150 stores messages, audio, video, configuration data, profile data, historical data, schedules, security profiles, access rules, content analysis rules, audit records, predefined rules, process definitions, financial data, and the like.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PUP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (I) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Referring again to FIG. 1, in one embodiment, when user 105 logs onto an application Internet server 125 may invoke an application server 145. Application server 145 invokes logic in the SWIM Engine 147 by passing parameters relating to the user's 105 requests for data. SMMS 115 manages requests for data from SMM Engine 147 and communicates with system 101 components. Transmissions between user 105 and Internet server 125 may pass through a firewall 120 to help ensure the integrity of SMMS 115 components. Practitioners will appreciate that the invention may incorporate any number of security schemes or none at all. In one embodiment, Internet server 125 receives requests from client 110 and interacts with various other system 101 components to perform tasks related to requests from client 110.

Internet server 125 may invoke an authentication server 130 to verify the identity of user 105 and assign roles, access rights and/or permissions to user 105. In order to control access to the application server 145 or any other component of SMMS 115, Internet server 125 may invoke an authentication server 130 in response to user 105 submissions of authentication credentials received at Internet server 125. When a request to access system 101 is received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

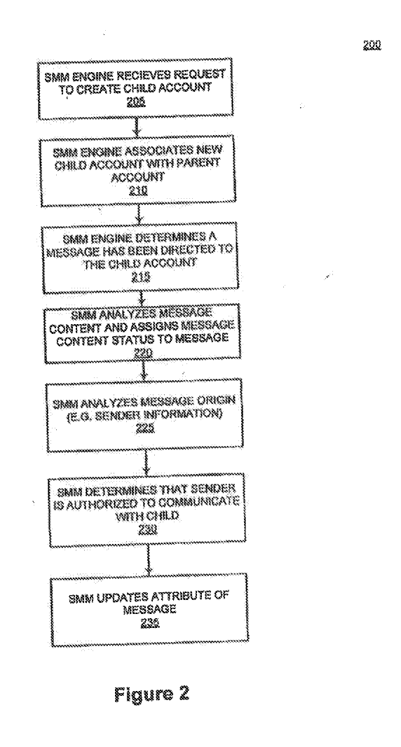

With reference to FIG. 2, in one embodiment, SMM Engine 147 executes a process to monitor requests sent to or from a user account. As disclosed previously, SMMS 115 enables analysis, tracking and monitoring of a wide variety of electronic messages. While discussed in terms of email messaging for purposes of illustration, one of skill in the art will recognize that the processes disclosed may be used to enable access control, monitoring and tracking of any type of electronic or data message (e.g., video, text, email, social networking messages or content).

In one embodiment, SMM Engine 147 receives a request to create a child account (Step 205). The request may be received from a user interface presented to a user 105. For instance, user 105 may be a user registered in SMMS 115 as a parent and the parent may be setting up an account for a child, SMM Engine 147 creates the child account and associates the child account with the parent account (Step 210). In one embodiment, a new account (in this case the child account) is not enabled to receive messages from any email address. In an embodiment, upon creating the child account SMM Engine 147 may associate the parent account and any other child account of the parent account (i.e., sibling accounts) such that the new child account may receive messages from the parent and the sibling account(s). In one embodiment, CDR 150 maintains master access lists (e.g., a contact list or an approved list) for each user account to specify messaging accounts that may communicate with a child account.

SMM Engine 147 determines that a message has been directed to the child account (Step 215). In an embodiment, CDR 150 maintains messaging data that is independent of the native messaging format or system. For instance, the access list maintained by CDR 150 may not be part of an email system and messages received via an email API or other email interface may be processed and/or parsed by SMM Engine 147 and stored in CDR 150. SMM Engine 147 analyzes the message based upon message content rules.

In an embodiment, the child account has received a request to communicate with another user via video or audio communication. The SMM Engine 147 intercepts the request and sends a notification to the parent account. The parent user may review the request and choose to approve or disapprove the type of communication being requested (e.g., video communication). In an embodiment, the types of communication are individually approved for each user; e.g., a user may be approved for email communication with a child but this does not authorize video communication with the child. Furthermore, approval of video communication may be contingent upon other restrictions such as time of day, type of user device, duration of an individual video communication and/or cumulative duration of video communication.

Message and/or transmitted content may be analyzed by any method known in the art for analyzing data. For instance, text matching, natural language analysis, expert systems, artificial intelligence, image analysis, video analysis, etc. In one embodiment, SMM 147 invokes a custom computer program configured to analyze images and compute a skin exposure factor. For example, the computer program is configured to identify when a large amount of skin (e.g. over percentage of skin) is displayed and/or when specific body types or body positions are portrayed in an image or video transmission. In an embodiment, if SMM 147 determines that a message content rule for video communication has been violated, SMM 147 may immediately disable the video messaging functionality of the child user and/or send an alert (e.g., SMS message or email message) to the parent account.

Message content rules may be system or user defined and may exist on CDR 150 or an external data source. For example, in an embodiment, SMM engine 147 accesses a dictionary of containing “bad words” that is stored in CDR 150 and SMM Engine 147 uses the dictionary, along with message content rules, to determine if the message contains content that is not to be displayed to children. In one embodiment, each parent maintains a separate dictionary of objectionable content that is used to analyze content based upon parent specific sensitivities. Similarly, custom rules may be built based upon any data accessible by the system. For example, a parent may wish to create age brackets for different types of objectionable content (e.g. a five-year old cannot see messages with the word “damn” but a thirteen year-old can).

In an embodiment, objectionable content may contain two or more different levels (e.g. red, yellow, amber) to indicate a relative degree, as determined by the content analysis, that the content is objectionable. In one embodiment, SMM Engine 147 is configured to execute rules in a variety of orders or hierarchies. For example, in one embodiment default system rules thr analyzing and determining objectionable content may be overridden by the parent and/or community specific rules. Based upon the analysis of the message content, SMM 147 assigns a message content status to the message (Step 220). In an embodiment, if the message content status indicates objectionable content, the message is sent automatically to the parent review interface, if the message content status indicates no objectionable content, then processing continues.

SMM 147 analyzes information regarding the origin of the message (e.g. message sender, domain or IP address from where the message was sent, etc.) (Step 225). In one embodiment, SMM 147 evaluates video transmission based upon the machine address of the sending machine and/or the domain of the transmission's origin or the route the video traverses to the child user device, SMM 147 accesses a user specific authorized sender list stored in CDR 150. In one embodiment, only transmissions from users listed on the authorized list will be made accessible to the child user. However, in an embodiment, SMM 147 may be configured to allow messages/transmissions from everyone except those senders appearing on a prohibited list. For example, SMM 147 may access an external database of sex offenders and prohibit any messages/transmissions from senders listed in that database. In an embodiment, other information regarding the sender may be accessed to determine whether a sender should have access to a child. For example, SMM 147 may be configured to determine whether the sender is already on an approved list for one of the child's siblings.

SMM 147 determines whether the sender is authorized to communicate with the child account (step 230). If the sender has not yet been authorized to communicate with the child account then the message is sent to a parent review interface. If the sender has already been identified (e.g., because of a previous message) as a prohibited sender for the child, the message may be deleted and/or archived. In one embodiment, even when a sender has been identified previously as an unauthorized sender, the message may still be directed to a parent interface so that the parent can monitor attempted contact from unauthorized users. In an embodiment, SMM 147 tracks a variety of statistics regarding messages and provides parents with a large variety of reports to monitor and track messages sent to child accounts.

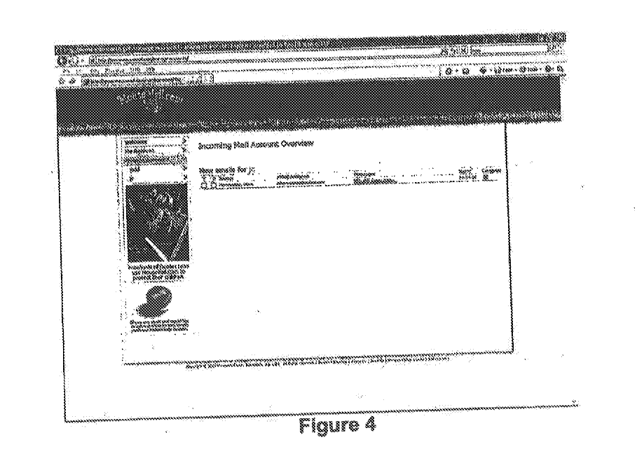

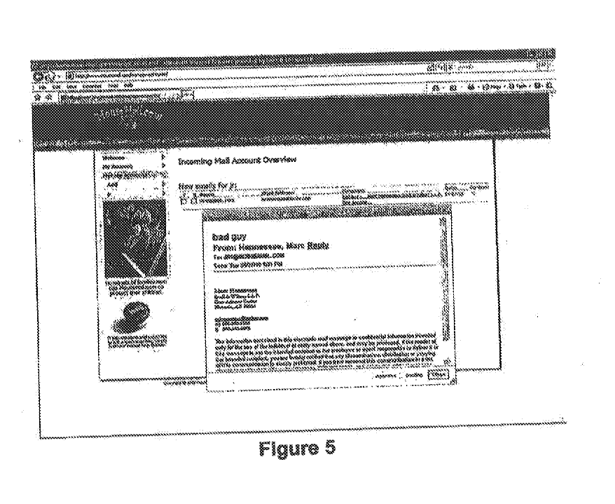

In one embodiment, the parent review interface displays all messages and/or requests to communicate sent to a child account associated with a parent account as well as all attempts by the child to send messages or to transmit video to another account. The parent review interface enables the parent to review messages that have not been delivered to the child for at least two possible reasons. First, the content of the message may be objectionable and second the origin of the message is objectionable. For example, FIG. 4 shows one embodiment of a parent review interface. The message shown in FIG. 4 on the parent review interface contains objectionable content. FIG. 5 shows a message that was sent to the parent review interface because the sender was not an approved sender.

The user associated with the parent account (e.g., the child's parent) reviews messages, and/or requests to communicate with the child, in the parent review interface. The parent review interface allows the parent to view why the message was not delivered by showing, for example, the specific rule or reason, for flagging the message as objectionable. For example, a parent may not realize that a specific word or phrase, which may seem innocuous in the parent's world, has evolved into a word or phrase that in the developing vernacular of children is objectionable. Thus, the parent is not only able to monitor and evaluate messages and determine whether a message should be delivered to the child but also to maintain awareness of potentially alarming aspects of their child's world.

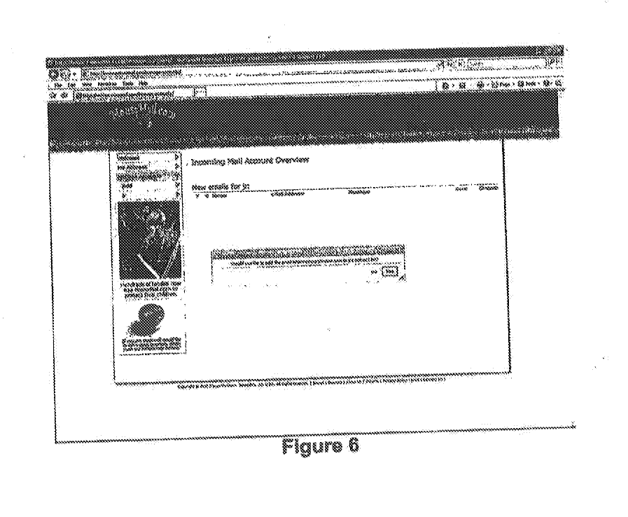

If a parent determines that a sender (e.g., user that has requested video communication) should be authorized to communicate with the child account, the parent indicates approval, for example, by clicking a checkbox or some other indicator on the parent approval interface. FIG. 6 shows the parent review interface, in this embodiment after the parent has indicated that a sender should be authorized to send the child messages, the parent is presented with the confirmation message. SMM Engine 147 receives the indication of approval from the parent review interface and updates an attribute of the message to enable the message to be accessed by the child account (Step 235). In an embodiment, once a sender has been approved to communicate with a child, SMMS 115 may allow future messages to be received from the sender without parent approval. For instance, SMM 147 may add the sender to an approved sender list, stored on CDR 150, for the child. In one embodiment, an approved sender may be approved only for limited time period or may be approved for one type of messaging or content. For example, the parent may allow messages from the sender only during the school year or only until the end of a sports season. Similarly, the parent may approve the child to receive SMS messages from the sender but not MMS messages, or the parent may allow the child to receive email messages from the sender but may not allow the email messages to contain any attachments.

In one embodiment, SMMS 115 controls and tracks messaging sent from a child account in a manner analogous to that described for receiving messages. For example, CDR 150 keeps a list of approved recipients to whom the child may send messages or with whom the child is authorized to conduct video communications. SMM 147 detects an attempt by the child to send a message and analyzes the message for content and to determine if the recipient is an authorized recipient. The parent approval interface is used by the parent to review requests by the child to send a message and the parent may approve of or deny/restrict content, manually block messages, and approve of or prohibit that the child send messages to a particular recipient.

In an embodiment, the SMMS 115 serves as a location based services provider. For example, SMMS 115 is configured with global positioning system (GPS) functionality that enables SMMS 115 to determine the location of a child's mobile device. Based upon a system or user customized rule (e.g., a rule stored in CDR 150) SMMS 115 may determined that the child is in a location (e.g., school, church) where sending and/or receiving messages (e.g. text messages) may be prohibited. SMMS 115 may store the message and deliver it only when the child moves to an authorized location. Such rules based upon location may be combined in any manner with other rules for delivering or sending messages. For example, SMMS 115 may generally prohibit messages sent from a child's mobile device that is located at a school but may allow such messages if the messages are being sent to the parent.

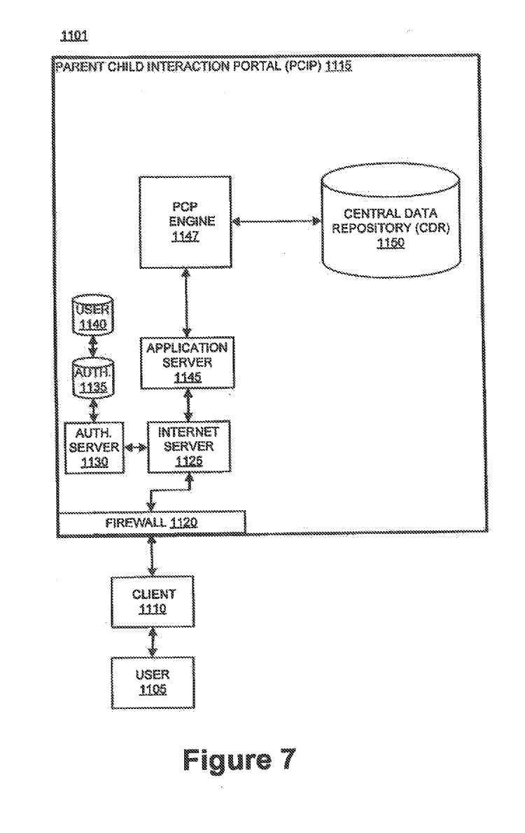

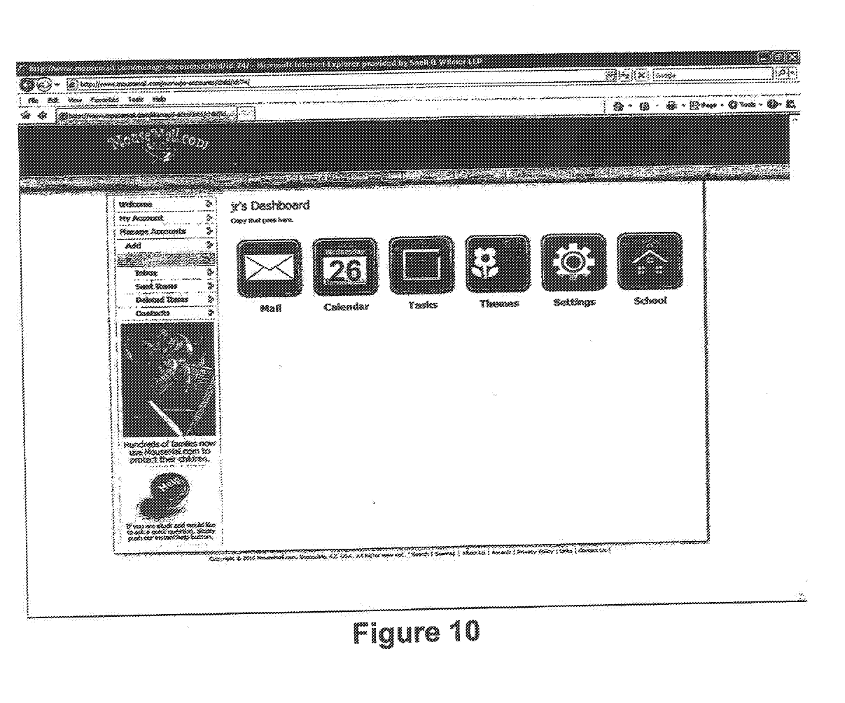

In yet another exemplary embodiment and with reference to FIGS. 7-13, the present invention fundamentally changes the way children communicate electronically. The invention improves upon existing systems by providing a tangible, integrated, safe online communication portal for children. The invention may be implemented by a system or a method or any combination of systems and methods. The parent child interaction portal (“PCIP”) may allow a user (e.g., a parent) to interact with and to control access and monitor activity with a second user (e.g., a child). In one embodiment, the system described herein can be incorporated within or used in conjunction with a message monitoring system described in co pending U.S. Patent Application “Message Monitoring System” filed on Apr. 30, 2010 and assigned Ser. No. 61/329,957 which is incorporated by reference in its entirety. In one embodiment, PCIP enables a parent, a child and other users authorized by the parent to share calendars, tasks, activities and online content in a safe, monitored online environment. Although an online portal interface is often used to illustrate the functionality enabled by PCIP, one skilled in the art will recognize that, in various embodiments, both the functions and the interface may vary to provide enhanced features or functionality. For example, PCIP functionality may be enabled for example, on a mobile device (e.g., a cell phone), a gaming device or console or on a web-enabled television. In one embodiment, PCIP functionality enables messaging, communication and data sharing aspects of a social network or online community. For instance, a parent (or other authorized person) may provide approval for contacts/friends who may interact with a child on a social network and message content analysis may be used to monitor, flag, filter or delete content that the social network (or one of it's members) finds objectionable.

While the embodiments described herein are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, PCIP includes a user interface (UI) (e.g. a virtual world), a software module, logic engines, numerous databases and computer networks. While PCIP may contemplate upgrades or reconfigurations of existing processing systems, changes to existing databases and system tools are not necessarily required by the present invention.

The benefits provided by this invention include, for example, increased security, monitoring, usability, functionality, comfort, familiarity and efficiency in online interaction. For example, parents and children benefit from a structured scheduling and task interaction that allows parents to communicate priorities and to teach children valuable life skills. Parents benefit from the assurance of multi-level safeguards against unwanted and potentially dangerous contact with their children while still enabling their children an aspect of freedom to use and learn in an online environment.

While the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as mobile phones, smart phones, tablet computing devices, etc.

A “user” may include any individual, entity, software and/or hardware that interacts with a system and/or participates in a process. With reference to FIG. 7, user 1105 may perform tasks such as receiving a request for interaction (e.g., to become a friend of another user, become a member of a virtual organization, etc.) initiating a communication, receiving a communication, assigning a task, receiving a task, scheduling an activity, and requesting, retrieving, receiving, updating, analyzing and/or modifying data. User 1105 may interface with Internet server 1125 via any communication protocol, device or method discussed herein, known in the art, or later developed. User 1105 may be, for example, a parent, a child, teacher, a friend, a classmate, a coach, or a system administrator.

In one embodiment, with reference to FIG. 7, system 1101 includes a user 1105 interfacing with a PCIP 1115 by way of a client 1110. PCIP 1115 is a fully integrated system comprised of various subsystems, modules and databases. Client 1110 comprises any hardware and/or software suitably configured to facilitate entering, accessing, requesting, retrieving, updating, analyzing, entering and/or modifying data. The data may include communication data (e.g. email, text or multi-media messages), audio content, video content, graphics, files, verification data, authentication data, instructional data, demographic data, transaction data, or any information discussed herein.

Client 1110 includes any device (e.g., personal computer), which communicates (in any manner discussed herein) with the PCIP 1115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 1110 may or may not be in direct contact with the PCIP 1115. For example, the client 1110 may access the services of the PCIP 1115 through another server, which may have a direct or indirect connection to Internet server 1125.

User 1105 may communicate with the PCIP 1115 through a firewall 1120 to help ensure the integrity of the PCIP 1115 components. Internet server 1125 may include any hardware and/or software suitably configured to facilitate communications between the client 1110 and one or more PCIP 1115 components.

Firewall 1120, as used herein, may comprise any hardware and/or software suitably configured to protect PCIP 1115 components from users of other networks. Firewall 1120 may reside in varying configurations including stateful inspection, proxy based and packet filtering, among others. Firewall 1120 may be integrated as software within Internet server 1125, any other system 1101 component, or may reside within another computing device or may take the form of a standalone hardware component.

Authentication server 1130 may include any hardware and/or software suitably configured to receive authentication credentials, encrypt and decrypt credentials, authenticate credentials, and/or grant access rights according to pre-defined privileges associated with the credentials. Authentication server 1130 may grant varying degrees of application and data level access to users based on information stored within authentication database 1135 and user database 1140. Application server 1145 may include any hardware and/or software suitably configured to serve applications and data to a connected client 11100

According to one embodiment, PCIP 1115 is used to manage and integrate messaging portal, and message monitoring and routing capabilities. PCIP 1115 is a fully integrated system comprised of various subsystems, modules and databases. With reference again to FIG. 7, PCIP 1115 allows communication with a central data repository (“CDR”) 150 and various other portals and UIs (not shown in FIG. 7). In one embodiment. UN are accessed via a web portal to interact with and/or participate in a virtual world. For instance, a user may make friend with and communicate with other avatars, may conduct virtual commerce, may acquire and sell virtual property, may earn virtual income and may create virtual objects. A user may also review and exchange tasks and calendar events, send and receive chat message, email messages, text messages (e.g., short message service (SMS)), multimedia messaging service (MMS) messages and the like. PCIP 1115 components are interconnected and communicate with one another to allow for a completely integrated portal into the virtual world that allows users, for example, to schedule appointments and activities, assign and approve tasks, document completion of tasks, approve/disapprove contacts for a child, approve/disapprove messaging content, etc.

Parent child portal engine (“PCP Engine”) 1147 is a software module configured to enable online functions such as sending and receiving messages, creating news feeds, creating tasks and schedule, executing and enforcing business rules, receiving query requests, configuring responses, dynamically configuring user interfaces, requesting data, receiving data, displaying data, streaming audio and/or video data, prompting user 1105 with security challenges, verifying user responses, authenticating the user, initiating PCIP 1115 processes and workflow, initiating other software modules, encrypting and decrypting. Additionally, PCP Engine 1147 may include, any hardware and/or software suitably configured to receive requests from client 1110 via Internet server 1125 and the application server 1145, PCP Engine 1147 is further configured to process requests, execute transactions, construct database queries, and/or execute queries against databases, within system 1101 (e.g., central data repository (“CDR”) 1150), external data sources and temporary databases. In one embodiment, PCP Engine 1147 is configured to execute application programming interfaces in order to communicate with a variety of messaging platforms such as, for instance, email systems, wireless communications systems, mobile communications systems, multimedia messaging systems (“MMS”) and protocols, text messaging systems and protocols (e.g., short message service or “SMS”) and the like. For example, in one embodiment, PCP Engine 1147 is configured to interface with any email gateway or protocol known in the art.

PCP Engine 1147 is configured to exchange data with other systems and application modules. In one embodiment, the PCP Engine 1147 may be configured to interact with other system 1101 components to evaluate rules, enforce restrictions, perform complex calculations, retrieve additional data, format data into reports, create XML representations of data, construct markup language documents, construct, define or control UIs, and/or the like. Moreover, PCP Engine 1147 may reside as a standalone system or may be incorporated with the application server 1145 or any other PCIP 1115 component as program code. As one of ordinary skill in the art will appreciate, PCP Engine 1147 may be logically or physically divided into various subcomponents such as a workflow engine configured to evaluate predefined rules and to automate processes associated with a messaging system and/or social network in PCIP 1115.

In addition to the components described above, PCIP 1115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 1101 components may take the form of an entirely software embodiment, an entirely hardware embodiment, or an embodiment combining aspects of both software and hardware. Furthermore, individual system 1101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Client 1110 may include an operating system (e.g., Windows XP, Windows NT, 95/98/2000, XP, Windows 7, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 1110 may be in any environment with access to any network, including both wireless and wired network connections. In an embodiment, access is through a network or the Internet through a commercially available web-browser software package. Client 1110 and PCIP 1115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 1110 is partially or fully connected to a network using a wired (“hard wire”) connection. As those skilled in the art will appreciate, client 1110 and/or any of the system components may include wired and/or wireless portions.

Internet server 1125 may be configured to transmit data to client 1110 within markup language documents. “Data” may include encompassing information such as commands, messages, transaction requests, queries, files, data for storage, and/or the like in digital or any other form. Internet server 1125 may operate as a single entity in a single geographic location or as separate computing components located together or in separate geographic locations. Further, Internet server 1125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. In one embodiment, Linux, Apache, Informix MySQL and PHP hypertext processor are used to enable the online portal. Additionally, components such as Access or Microsoft SQL Server, Oracle, Sybase, MySQL, InterBase, etc., may be used to provide an Active Data Object (ADO) compliant database management system.

Like Internet server 1125, application server 1145 may communicate with any number of other servers, databases and/or components through any means known in the art. Further, application server 1145 may serve as a conduit between client 1110 and the various systems and components of PCIP 1115. Internet server 1125 may interface with application server 1145 through any means known in the art including a IAN/WAN, for example. Application server 1145 may further invoke software modules such as the PCP Engine 1147, automatically or in response to user 1105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), PHP, common gateway interface scripts (CGI). Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 7 depicts databases that are included in an exemplary embodiment of the invention. An exemplary list of various databases used herein includes: an authentication database 1135, a user database 1140, CDR 1150 and/or other databases that aid in the functioning of the system. As practitioners will appreciate, while depicted as separate and/or independent entities for the purposes of illustration, databases residing within system 1101 may represent multiple hardware, software, database, data structure and networking components. Furthermore, embodiments are not limited to the exemplary databases described herein, nor do embodiments necessarily utilize each of the disclosed exemplary databases.

Authentication database 1135 may store information used in the authentication process such as, for example, user identifiers, passwords, access privileges, user preferences, user statistics, and the like. User database 1140 maintains user information and credentials for PCIP 1115 users (e.g., user 1105).

CDR 1150 is a data repository that is configured to store a wide variety of comprehensive data for PCIP 1115. While depicted as a single logical entity in FIG. 7, those of skill in the art will appreciate that CDR 1150 may, in some embodiments, consist of multiple physical and/or logical data sources. In one embodiment, CDR 1150 stores avatar definitions, messages, audio, video, configuration data, profile data, historical data, schedules, security profiles, access rules, content analysis rules, audit records, predefined rules, process definitions, financial data, and the like.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of system 1101 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code in C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall. These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Referring again to FIG. 7, in one embodiment, when user 1105 logs onto an application Internet server 1125 may invoke an application server 1145. Application server 1145 invokes logic in the PCP Engine 1147 by passing parameters relating to the user's 1105 requests for data. PCIP 1115 manages requests for data from PCP Engine 1147 and communicates with system 1101 components. Transmissions between user 1105 and Internet server 1125 may pass through a firewall 1120 to help ensure the integrity of PCIP 1115 components. Practitioners will appreciate that the invention may incorporate any number of security schemes or none at all. In one embodiment, Internet server 1125 receives requests from client 1110 and interacts with various other system 1101 components to perform tasks related to requests from client 1110.

Internet server 1125 may invoke an authentication server 1130 to verify the identity of user 1105 and assign roles, access rights and/or permissions to user 1105. In order to control access to the application server 1145 or any other component of PCIP 1115, Internet server 1125 may invoke an authentication server 1130 in response to user 1105 submissions of authentication credentials received at Internet server 1125. When a request to access system 1101 is received from Internet server 1125, Internet server 1125 determines if authentication is required and transmits a prompt to client 1110. User 1105 enters authentication data at client 1110, which transmits the authentication data to Internet server 1125. Internet server 1125 passes the authentication data to authentication server which queries the user database 1140 for corresponding credentials. When user 1105 is authenticated, user 1105 may access various applications and their corresponding data sources.

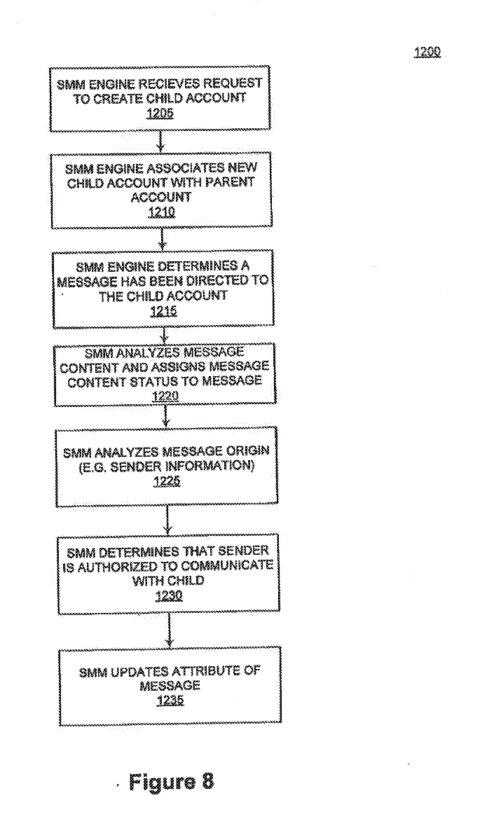

With reference to FIG. 8, in one embodiment, PCP Engine 1147 executes a process to monitor messages sent to or from a user account, As disclosed previously, PCIP 1115 enables analysis, tracking and monitoring of a wide variety of electronic messages. While discussed in terms of internal email messaging for purposes of illustration, one of skill in the art will recognize that the processes disclosed may be used to enable access control, monitoring and tracking of any type of electronic or data message (e.g., text, email, chat, social networking messages or content).

In one embodiment, PCP Engine 1147 receives a request to create a child account (Step 1205). The request may be received from a user interface presented to a user 1105. For instance, user 1105 may be a user registered in PCIP 1115 as a parent and the parent may be setting up an account for a child. PCP Engine 1147 creates the child account and associates the child account with the parent account (Step 1210). In one embodiment, a new account (in this case the child account) is not enabled to receive messages from any address. “Address” includes any representation or identifier of a user, a user account or a messaging or communication repository. In an embodiment, upon creating the child account PCP Engine 1147 may associate the parent account and any other child account of the parent account (i.e., sibling accounts) such that the new child account may receive messages from the parent and the sibling account(s). In one embodiment, CDR 1150 maintains master access lists (e.g., a contact list or an approved list) for each user account to specify messaging accounts that may communicate with a child account.

PCP Engine 1147 determines that a message has been directed to the child account (Step 1215). In an embodiment, CDR 1150 maintains messaging data that is independent of the native messaging format or system. For instance, the access list maintained by CDR 1150 may not be part of an email system and messages received via an email API, or other email interface, may be processed and/or parsed by PCP Engine 1147 and stored in CDR 1150, PCP Engine 1147 analyzes the message based upon message content rules. Message content may be analyzed by any method known in the art for analyzing data. For instance, text matching, natural language analysis, expert systems, artificial intelligence, image analysis, video analysis, etc. in one embodiment, PCP 1147 invokes a custom computer program configured to analyze images and compute a skin exposure factor. For example, the computer program is configured to identify when a large amount of skin (e.g. over percentage of skin) is displayed and/or when specific body types or body positions are portrayed in an image or video file.

Message content rules may be system or user defined and may exist on CDR 1150 or an external data source. For example, in an embodiment, PCP engine 1147 accesses a dictionary of containing “bad words” that is stored in CDR 1150 and PCP Engine 1147 uses the dictionary, along with message content rules, to determine if the message contains content that is not to be displayed to children. In one embodiment, each parent maintains a separate dictionary of objectionable content that is used to analyze content based upon parent specific sensitivities. Similarly, custom rules may be built based upon any data accessible by the system. For example, a parent may wish to create age brackets for different types of objectionable content (e.g. a five-year old cannot see messages with the word “damn” but a thirteen year-old can).

In an embodiment, objectionable content may contain two or more different levels (e.g. red, yellow, amber) to indicate a relative degree, as determined by the message content analysis, that the content is objectionable. In one embodiment, PCP Engine 1147 is configured to execute rules in a variety of orders or hierarchies, For example, in one embodiment default system rules for analyzing and determining objectionable content may be overridden by the parent and/or community specific rules. Based upon the analysis of the message content, PCP 1147 assigns a message content status to the message (Step 1220). In an embodiment, if the message content status indicates objectionable content, the message is sent automatically to the parent review interface, if the message content status indicates no objectionable content, then processing continues.

PCP 1147 analyzes information regarding the origin of the message (e.g. message sender, domain or IP address from where the message was sent, etc.) (Step 1225). In one embodiment, PCP 1147 evaluates email messages based upon the sender's identity (e.g., avatar identification, email address, online identifier, etc.). PCP 1147 accesses a user specific authorized sender list stored in CDR 1150. In one embodiment, only messages from users listed on the authorized list will be made accessible to the child user account. However, in an embodiment, PCP 1147 may be configured to allow messages from everyone except those senders appearing on a prohibited list. For example, PCP 1147 may access an external database of sex offenders and prohibit any message or request from senders listed in that database. In an embodiment, other information regarding the sender may be accessed to determine whether a sender should have access to a child. For example, PCP 1147 may be configured to determine whether the sender is already on an approved list for one of the child's siblings.

PCP 1147 determines whether the sender is authorized to interact with the child account (step 1230). If the sender has not yet been authorized to communicate with the child account then the message is sent to a parent review interface. If the sender has already been identified (e.g., because of a previous message) as a prohibited sender for the child, the message may be deleted and/or archived. In one embodiment, even when a sender has been identified previously as an unauthorized sender, the message may still be directed to a parent interface so that the parent can monitor attempted contact from unauthorized users. As disclosed previously, the invention is not limited to evaluating messages from senders. For example, a message may include a request from another avatar to be a friend with the child account's avatar. In an embodiment. PCP 1147 tracks a variety of statistics regarding messages and other interactions and provides parents with a large variety of reports to monitor and track messages sent to child accounts.

In one embodiment, the parent review interface displays all messages, interactions and request sent to a child account associated with a parent account. The parent review interface enables the parent to review messages that have not been delivered to the child for at least two possible reasons. First, the content of the message may be objectionable and second the origin of the message is objectionable.

The user associated with the parent account (e.g., the child's parent) reviews messages in the parent review interface. The parent review interface allows the parent to view why the message was not delivered by showing, for example, the specific rule or reason, for flagging the message as objectionable. For example, a parent may not realize that a specific word or phrase, which may seem innocuous in the parent's world, has evolved into a word or phrase that in the developing vernacular of children is objectionable. Thus, the parent is not only able to monitor and evaluate messages and determine whether a message should be delivered to the child but also to maintain awareness of potentially alarming aspects of their child's world.

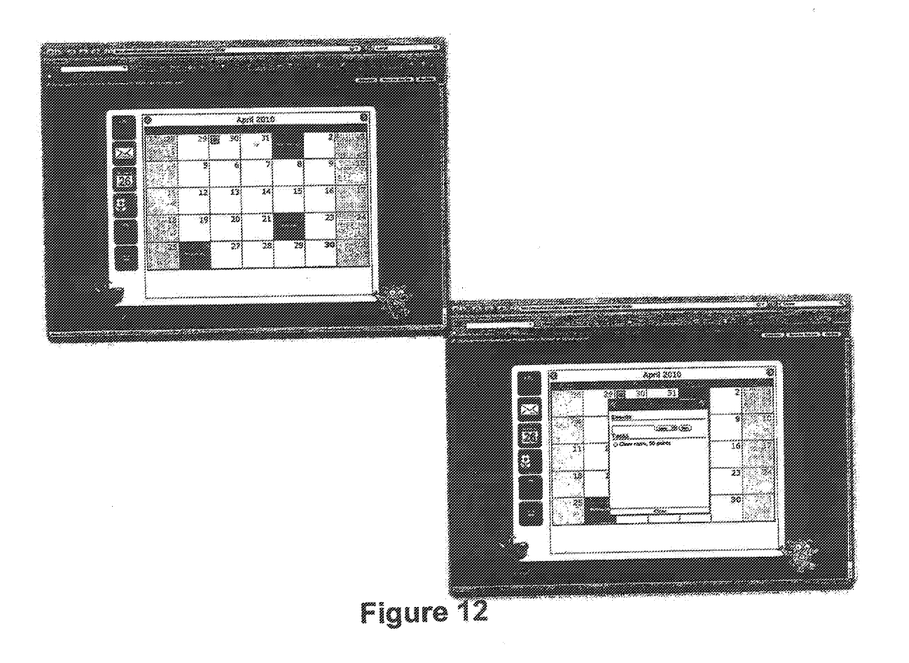

If a parent determines that a sender (e.g., of an interaction requests or a chat message) should be authorized to send messages to the child account, the parent indicates approval, for example, by clicking a checkbox or some other indicator on the parent approval interface. FIG. 12 shows the parent review interface, in this embodiment after the parent has indicated that a sender should be authorized to send the child messages, the parent is presented with the confirmation message, PCP Engine 1147 receives the indication of approval from the parent review interface and updates an attribute of the message to enable the message to be accessed by the child account (Step 1235). In an embodiment, once a sender has been approved to interact with a child, PCIP 1115 may allow future messages to be received from the sender without parent approval. For instance, PCP 1147 may add the sender to an approved sender list, stored on CDR 1150, for the child. In one embodiment, an approved sender may be approved only for limited time period or may be approved for one type of messaging or content. For example, the parent may allow messages from the sender only during the school year or only until the end of a sports season. Similarly, the parent may approve the child to receive text chat from the sender but not graphic or video chat, or the parent may allow the child to receive email messages from the sender but may not allow the email messages to contain any attachments.

In one embodiment, PCIP 1115 controls and tracks messaging sent from a child account in a manner analogous to that described for receiving messages. For example, CDR 1150 keeps a list of approved recipients to whom the child may send messages or from whom the child may request or initiate an online interaction (e.g., play a game together). PCP 1147 detects an attempt by the child to send a message and analyzes the message for content and to determine if the recipient is an authorized recipient. The parent approval interface is used by the parent to review requests by the child to send a message and the parent may approve of or deny/restrict content, manually block messages, and approve of or prohibit that the child send messages to a particular recipient.

In one embodiment, PCIP 1115 presents interfaces and controls functionality that enable a first user (e.g. a parent or teacher) to assign tasks to a second user (e.g., a child). For example, in one embodiment, a parent may wish to assign a task to a child and reward the child when the child completes (or partially completes) the task. Tasks may be assigned to a child directly or indirectly. For example, a teacher may be a user on the portal and may assign tasks such as homework assignments to a class of children. The teacher may set up the class and send invitations to the children to become members of the class. In one embodiment, a child can only become a member of a group, such as a class, if the parent reviews and approves the child's membership in the group.

In one embodiment, a child may become a member (e.g., after parent approval) of a group or organization. The group may be a virtual group and/or may have representation in the real world. For example, in an exemplary embodiment a child's avatar may wish to acquire a pet and may adopt a pet from a virtual humane society. The virtual humane society may award points or otherwise indicate a rating or achievement based upon the completion of online tasks associated with taking care of a pet. For instance, the child may be asked to feed the pet twice daily and to exercise the pet at least three times a week. If the child completes these tasks in the online world, the child may be rewarded in the online world or in the real world. For example, in the online world, the child may receive credit at a virtual pet boutique to acquire a special virtual collar for his pet. In another example, achievement of a specific sets of pet related tasks in the virtual world may allow a child to receive a certificate allowing the child to adopt a live pet in the real world (e.g. from the local humane society).

Similar to the process described above whereby a parent reviews and approves senders who may contact a child, PCIP 1115 provides an interface to the parent where the parent may view social networking invitations, such as an invitation to join a class, a team, a club or to become “friends” with another virtual user. Thus, if the child associated with the class, a teacher may assign a task to the class and, in an embodiment, PCIP 1115 will show the tasks in the child's portal interface. In one embodiment, tasks are categorized and or prioritized in the child view in order to provide simplification and focus to the child. The categorization and/or prioritization of tasks may be based upon default rules, custom rules or may be manually set by another user (such as the parent).

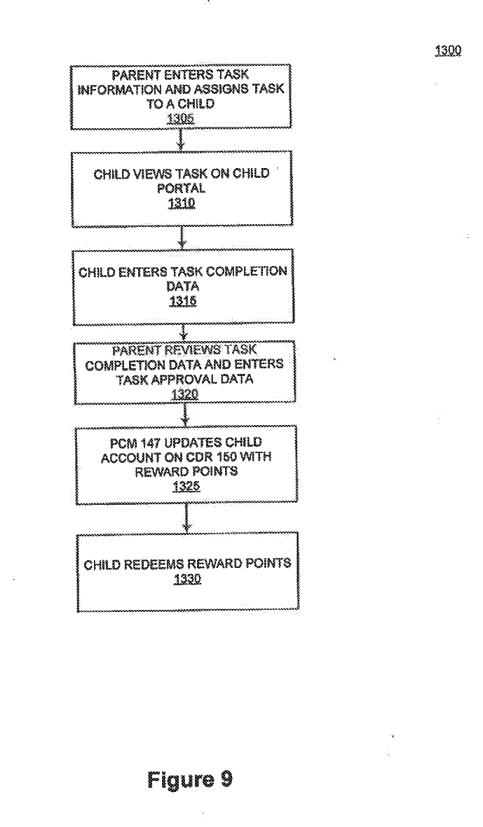

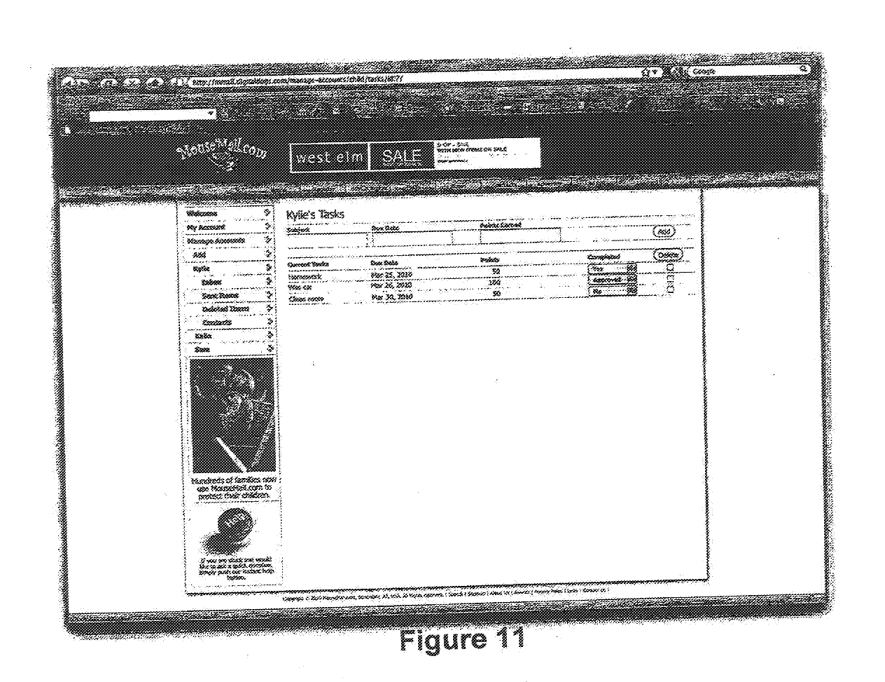

In one embodiment, PCIP Engine 1115, in conjunction with PCP 1147, provides interfaces and executes processes to enable task assignment, monitoring, progress reporting, completion reporting and completion point awards. FIG. 11 shows an exemplary screen shoot of such a point system. With reference again to FIG. 9, the parent logs into PCIP 1115 and selects a child and enters task information into the portal (Step 1305). For example, the task information may include a due date for the task, points associated with the task, a task description, content associated with the task (e.g., audio or video instructions), etc. In an embodiment, message content analysis (as described above) may be invoked to determine if the task contains any content that may be objectionable.

In one embodiment, points are awarded (or deducted) based upon the performance of the task; however in an embodiment points may be awarded automatically based upon, for example, the passage of time or number of user logins (as in the case of giving a child a weekly allowance), Point awards system may be set up by any user of the system or may be configured by default. A point award system may have multiple aspects and entities involved. For example, a parent may set up a simple points (or demerit) system whereby the child earns points toward an allowance (or some other reward) based upon successful completion of tasks. PCIP 1115 also enables implementation of more complex points such as loyalty systems used by many businesses to reward customer loyalty. Incentive award programs have been developed in a variety of industries to promote customer loyalty. Generally, such programs reward customers for repeat business with the same merchant or service provider by accumulating reward points which can then be redeemed in a plurality of ways, including exchanging the reward points for additional goods and services that may be selected from an approved list or a redemption catalog, for example. The reward points are usually calculated using a predetermined formula or ratio that relates a customer's positive behavior (i.e., purchase volume) to a certain number of reward points. For example, reward points may be issued on a one-for-one basis with each dollar that a customer spends on particular goods and services. Similarly, virtual and/or actual merchants may set up rewards systems in conjunction with PCIP 1115. For example, a local ice cream vendor may wish to run a promotion that rewards children for completing household chores on time. PCIP 1115 may provide a manual interface (user input screen) or a systematic interface (data interconnection, via e.g., the internet) to receive the parameters of a merchants award program. Parents may be notified of the promotion via the parent portal and opt-in their child for participation in the program. In an embodiment, once the child has earned a sufficient amount of qualifying points, the child may be enabled, via PCIP 1115 to print a coupon tier a free ice cream.

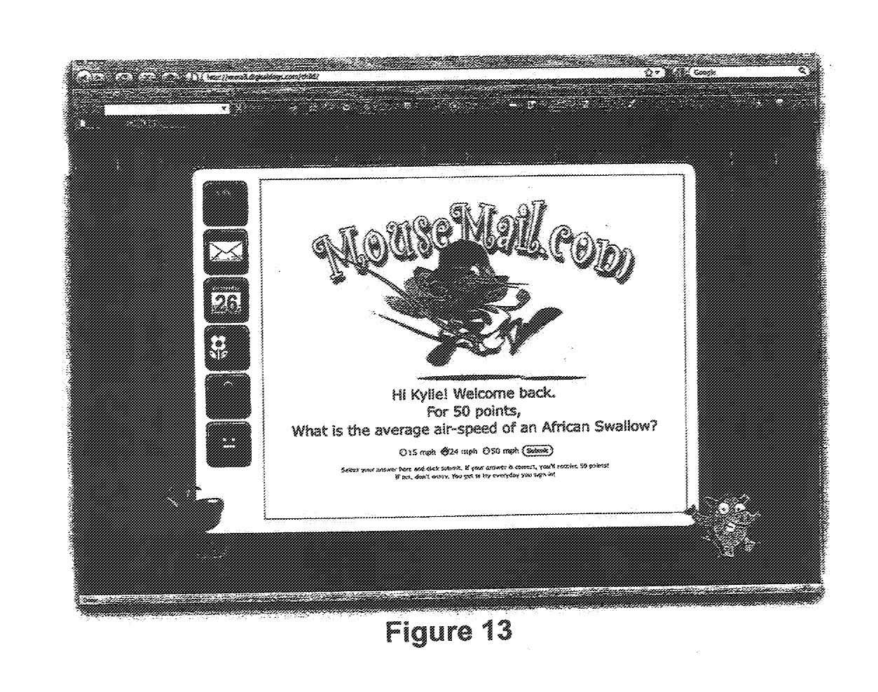

In one embodiment, PCIP 1115 presents an online quiz or game to the child that allows the child to earn points by answering questions correctly as shown in FIG. 13. For example, the child may be prompted in a virtual classroom to answer a math, science or history question with the child being rewarded a certain number of points when the child answers the question correctly. Questions may be stored in CDR 1150 and may be customized for the child (e.g. by a teacher or a parent). Furthermore, in an embodiment PCIP 1115 is configured with logic to limit a child accruing points beyond the scope or intention of the system. For example, if a trivia question is asked during login, the system may be configured to never ask the child the same question twice. Of, the system may be configured to limit the number of points a child may earn in a given timeframe, e.g., the system may only allow a child to accrue 10 points per day.

In an embodiment, task completion and/or rewards points may be linked to enabling (or disabling) other PCIP 1115 functionality. For instance, a “games” portion of the portal may be disabled until a certain task has been completed and approved by the parent. Or, text messaging on the child's mobile device may be enabled and monitored via PCIP 1115 and the text messaging functionality may be disabled if the child is unable to maintain a threshold level of reward points.

Referring again to FIG. 9, in response to receiving the task input, PCM 1147 saves the task to CDR 1150. The child (i.e., user that has been assigned the task) views the task on the child's portal interface (Step 1310). In an embodiment, the child may be proactively notified of a new task (e.g., a text message is sent to the child's phone). The child enters information regarding the completion of the task (Step 1315). The task completion data may be complete or partial, e.g., “completed” or “washed 1 of 2 cars.” The parent (i.e., the user that assigned the task) may view the task completion data and determine whether to accept it, reject it, and assign a new/related task, reward points or some combination of these by entering task approval data (Step 1320). Based upon the parent's review of the task completion data, PCM 1147 executes business rules to determine thr example, whether, how much and to whom to credit reward points (Step 1325).

In addition to and in conjunction with providing task assignment functionality, in one embodiment, PCIP 1115 enables individual and group calendaring functionality. FIG. 12 shows screen shots of an exemplary calendar and a point system associated with the calendar as described herein. In an embodiment, tasks that have dates associated with them (e.g., due dates, completion dates, milestone dates, etc) are automatically displayed on a child's calendar. In an embodiment, PCM 1147 automatically determines when a notification needs to be sent out for an upcoming activity or event (stored on the calendar) or a pending task. Notifications may be sent out by text, email, or phone message. In one embodiment, a group calendar shows all the tasks and appointments/activities/events of a group (e.g., family) itself and of all the users (e.g., children) associated with the group. In an embodiment, the group calendar is configurable to selectively show or hide data associated with an individual member. Thus a family of five may be able to view the calendar of the family only, the family's calendar and all the calendar items of two of the children, the calendar items of all three children only, etc. Furthermore, calendar items may be filtered by category and priority.

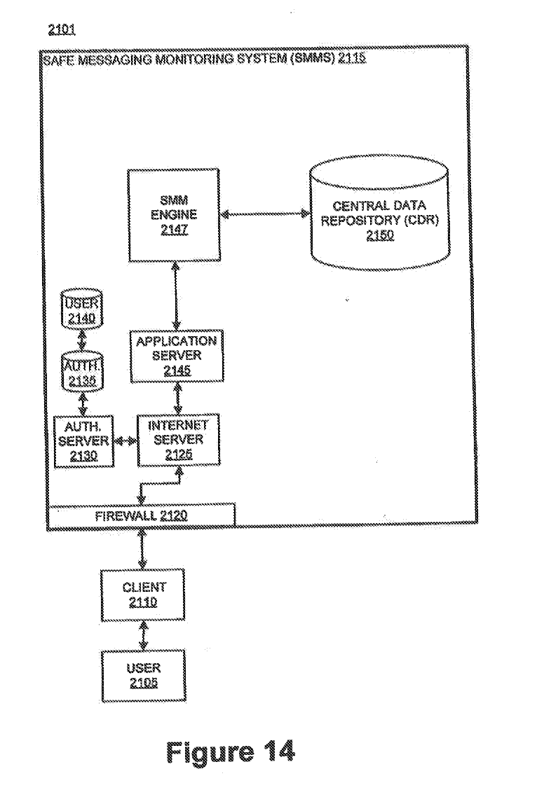

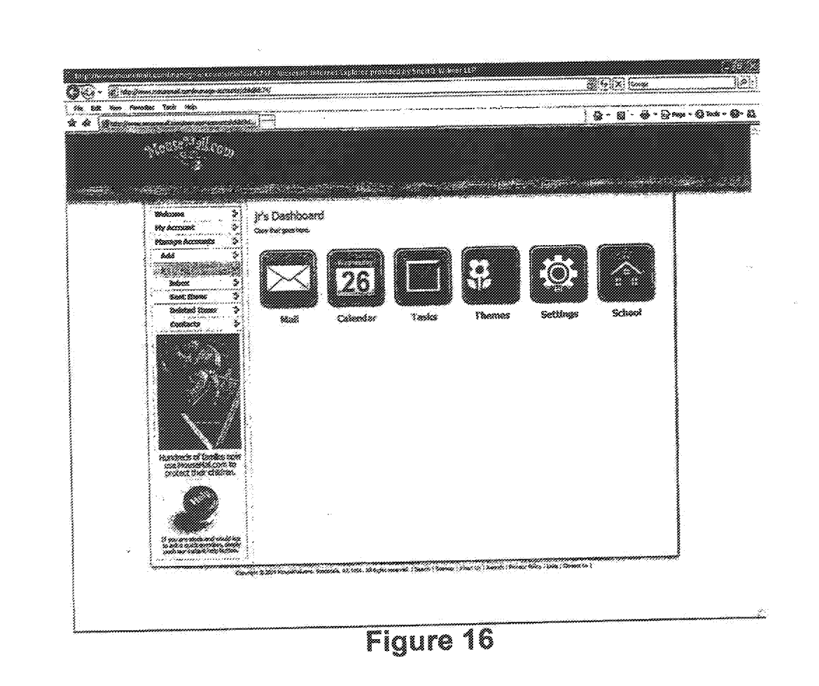

In yet another exemplary embodiment and with reference to FIGS. 14-20, the present invention fundamentally changes the way children communicate electronically. The invention improves upon existing systems by providing a tangible, integrated, safe online communication portal for children. The invention may be implemented by a system or a method or any combination of systems and methods. The Safe World further may include a safe messaging monitoring system (“SMMS”) that may allow a user (e.g., a parent) control access to and monitor communications with a second user (e.g., a child). In one embodiment, SMMS enables chat, text, audio and/or video interaction in a safe and monitored environment. Although online email or text message is often used to illustrate the functionality enabled by SMMS, one skilled in the art will recognize that, in various embodiments, both the functions and the interface may vary to provide enhanced features or functionality. For example, SMMS functionality may be enabled for example, on a mobile device (e.g., a cell phone), a gaming device or console or on a web-enabled television, in one embodiment, SMMS functionality enables messaging, communication and data sharing aspects in a virtual world, social network or an online community. For instance, a parent (or other authorized person) may provide approval for contacts/friends who may interact with a child in a virtual world and message content analysis may be used to monitor, flag, filter or delete content that the virtual (or one of its members) finds objectionable.

While the embodiments described herein are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, SMMS includes a user interface (UI), a software module, logic engines, numerous databases and computer networks. While SMMS may contemplate upgrades or reconfigurations of existing processing systems, changes to existing databases and system tools are not necessarily required by the present invention.

The benefits provided by this invention include, for example, increased security, monitoring, usability, functionality, comfort, familiarity and efficiency in text communications. For example, children benefit from a controlled messaging environment to communicate with “safe” friends while learning valuable computer and online communications skills. Parents benefit from the assurance of multi-level safeguards against unwanted and potentially dangerous contact with their children while still enabling their children an aspect of freedom to use and learn online communication tools.

While the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as mobile phones, smart phones, tablet computing devices, etc.

A “user” may include any individual, entity, software and/or hardware that interacts with a system and/or participates in a process. With reference to FIG. 14, user 2105 may perform tasks such as initiating a communication, receiving a communication, and requesting, retrieving, receiving, updating, analyzing and/or modifying data. User 2105 may interface with Internet server 2125 via any communication protocol, device or method discussed herein, known in the art, or later developed. User 2105 may be, for example, a parent, a child, teacher, a friend, a classmate, a coach, or a system administrator.

In one embodiment, with reference to FIG. 14, system 2101 includes a user 2105 interfacing with a SMMS 2115 by way of a client 2110. SMMS 2115 is a fully integrated system comprised of various subsystems, modules and databases. Client 2110 comprises any hardware and/or software suitably configured to facilitate entering, accessing, requesting, retrieving, updating, analyzing, entering and/or modifying data. The data may include communication data (e.g. email, audio, video, text, graphics, files, etc), verification data, authentication data, instructional data, demographic data, transaction data, or any information discussed herein.

Client 2110 includes any device (e.g. mobile phone), which communicates (in any manner discussed herein) with the SMMS 2115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 2110 may or may not be in direct contact with the SMMS 2115. For example, the client 2110 may access the services of the SMMS 2115 through another server, which may have a direct or indirect connection to Internet server 2125.

User 2105 may communicate with the SMMS 2115 through a firewall 2120 to help ensure the integrity of the SMMS 2115 components. Internet server 2125 may include any hardware and/or software suitably configured to facilitate communications between the client 2110 and one or more SMMS 2115 components.

Firewall 2120, as used herein, may comprise any hardware and/or software suitably configured to protect SMMS 2115 components from users of other networks. Firewall 2120 may reside in varying configurations including stateful inspection, proxy based and packet filtering, among others. Firewall 2120 may be integrated as software within Internet server 2125, any other system 2101 component, or may reside within another computing device or may take the form of a standalone hardware component.

Authentication server 2130 may include any hardware and/or software suitably configured to receive authentication credentials, encrypt and decrypt credentials, authenticate credentials, and/or grant access rights according to pre-defined privileges associated with the credentials. Authentication server 2130 may grant varying degrees of application and data level access to users based on information stored within authentication database 2135 and user database 2140. Application server 2145 may include any hardware and/or software suitably configured to serve applications and data to a connected client 2110.

According to one embodiment, SMMS 2115 is used to manage and integrate messaging portal, and message monitoring and routing capabilities. SMMS 2115 is a fully integrated system comprised of various subsystems, modules and databases. With reference again to FIG. 14, SMMS 2115 allows communication with a central data repository (“CDR”) 2150 and various other portals and UIs (not shown in FIG. 14). In one embodiment, UIs are accessed via a web portal to send and receive email messages, text messages (e.g., short message service (SMS)), multimedia messaging service (MMS) messages and the like. SMMS 2115 components are interconnected and communicate with one another to allow for a completely integrated online messaging portal that allows users, for example, to send and receive email communications, approve/disapprove contacts for a child, approve/disapprove messaging content, etc.

Safe message monitoring engine (“SMM Engine”) 2147 is a software module configured to enable online functions such as sending and receiving messages, receiving query requests, configuring responses, dynamically configuring user interfaces, requesting data, receiving data, displaying data, streaming audio and/or video data, prompting user 2105 with security challenges, verifying user responses, authenticating the user, initiating SMMS 2115 processes, initiating other software modules, encrypting and decrypting. Additionally, SMM Engine 2147 may include any hardware and/or software suitably configured to receive requests from client 2110 via Internet server 2125 and the application server 2145. SMM Engine 2147 is further configured to process requests, execute transactions, construct database queries, and/or execute queries against databases, within system 2101 (e.g., central data repository (“CDR”) 2150), external data sources and temporary databases, in one embodiment, SMM Engine 2147 is configured to execute application programming interfaces in order to communicate with a variety of messaging platforms such as, for instance, email systems, wireless communications systems, mobile communications systems, MMS systems, SMS systems and the like, For example, in one embodiment, SMM Engine 2147 is configured to interface with a Mobile Number Portability (MNP) service (also known as “IMSI-lookup”, “Network Look up Service” or “HLR Lookup”) or other network query service used to identify Mobile phone networks (e.g., Mobile Station Integrated Services Digital Networks or “MSISDN”).

SMM Engine 2147 is configured to exchange data with other systems and application modules. In one embodiment, the SMM Engine 2147 may be configured to interact with other system 2101 components to perform complex calculations, retrieve additional data, format data into reports, create XML representations of data, construct markup language documents, construct, define or control UIs, and/or the like. Moreover, SMM Engine 2147 may reside as a standalone system or may be incorporated with the application server 2145 or any other SMMS 2115 component as program code. As one of ordinary skill in the art will appreciate, SMM Engine 2147 may be logically or physically divided into various subcomponents such as a workflow engine configured to evaluate predefined rules and to automate processes associated with a messaging system and/or social network in SMMS 2115.

In addition to the components described above, SMMS 2115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 2101 components may be embodied as a customization of an existing system, an add-on product, upgraded software, a stand-alone system (e.g., kiosk), a distributed system, a method, a data processing system, a device for data processing, and/or a computer program product. Accordingly, individual system 2101 components may take the form of an entirely software embodiment, an entirely hardware embodiment, or an embodiment combining aspects of both software and hardware. Furthermore, individual system 2101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Client 2110 may include an operating system (e.g., Windows XP, Windows NT, 95/98/2000, XP, Windows 7, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 2110 may be in any environment with access to any network, including both wireless and wired network connections. In an embodiment, access is through a network or the Internet through a commercially available web-browser software package. Client 2110 and SMMS 2115 components may be independently, separately or collectively suitably coupled to the network via data links which includes, for example, a connection to an Internet Service Provider (ISP) over the local loop as is typically used in connection with standard wireless communications networks and/or methods, modern communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 2110 and/or any of the system components may include wired and/or wireless portions.

Internet server 2125 may be configured to transmit data to client 2110 within markup language documents, “Data” may include encompassing information such as commands, messages, transaction requests, queries, files, data for storage, and/or the like in digital or any other form. Internet server 2125 may operate as a single entity in a single geographic location or as separate computing components located together or in separate geographic locations. Further, Internet server 2125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. In one embodiment, Linux, Apache, Informix MySQL and PHP hypertext processor are used to enable SMMS 115. Additionally, components such as Access or Microsoft SQL Server, Oracle, Sybase, InterBase, etc., may be used to provide an Active Data Object (ADO) compliant database management system.

Like Internet server 2125, application server 2145 may communicate with any number of other servers, databases and/or components through any means known in the art. Further, application server 2145 may serve as a conduit between client 2110 and the various systems and components of SMMS 2115. Internet server 2125 may interface with application server 2145 through any means known in the art including a LAN/WAN, for example. Application server 2145 may further invoke software modules such as the SMM Engine 2147, automatically or in response to user 2105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 14 depicts databases that are included in an exemplary embodiment of the invention. An exemplary list of various databases used herein includes: an authentication database 2135, a user database 2140, CDR 2150 and/or other databases that aid in the functioning of the system. As practitioners will appreciate, while depicted as separate and/or independent entities for the purposes of illustration, databases residing within system 2101 may represent multiple hardware, software, database, data structure and networking components. Furthermore, embodiments are not limited to the exemplary databases described herein, nor do embodiments necessarily utilize each of the disclosed exemplary databases.

Authentication database 2135 may store information used in the authentication process such as, for example, user identifiers, passwords, access privileges, user preferences, user statistics, and the like. User database 2140 maintains user information and credentials for SMMS 2115 users (e.g., user 2105).

CDR 2150 is a data repository that is configured to store a wide variety of comprehensive data for SMMS 2115. While depicted as a single logical entity in FIG. 14, those of skill in the art will appreciate that CDR 2150 may, in some embodiments, consist of multiple physical and/or logical data sources, in one embodiment, CDR 2150 stores messages, audio, video, configuration data, profile data, historical data, schedules, security profiles, access rules, content analysis rules, audit records, predefined rules, process definitions, financial data, and the like.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of system 2101 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Referring again to FIG. 14, in one embodiment, when user 2105 logs onto an application Internet server 2125 may invoke an application server 2145. Application server 2145 invokes logic in the SMM Engine 2147 by passing parameters relating to the user's 2105 requests for data. SMMS 2115 manages requests for data from SMM Engine 2147 and communicates with system 2101 components. Transmissions between user 2105 and Internet server 2125 may pass through a firewall 2120 to help ensure the integrity of SMMS 2115 components. Practitioners will appreciate that the invention may incorporate any number of security schemes or none at all. In one embodiment, Internet server 2125 receives requests from client 110 and interacts with various other system 2101 components to perform tasks related to requests from client 2110.

Internet server 2125 may invoke an authentication server 2130 to verify the identity of user 2105 and assign roles, access rights and/or permissions to user 2105. In order to control access to the application server 2145 or any other component of SMMS 2115, Internet server 2125 may invoke an authentication server 2130 in response to user 2105 submissions of authentication credentials received at Internet server 2125. When a request to access system 2101 is received from Internet server 2125, Internet server 2125 determines if authentication is required and transmits a prompt to client 2110. User 2105 enters authentication data at client 2110, which transmits the authentication data to Internet server 2125. Internet server 2125 passes the authentication data to authentication server which queries the user database 2140 for corresponding credentials. When user 2105 is authenticated, user 2105 may access various applications and their corresponding data sources.

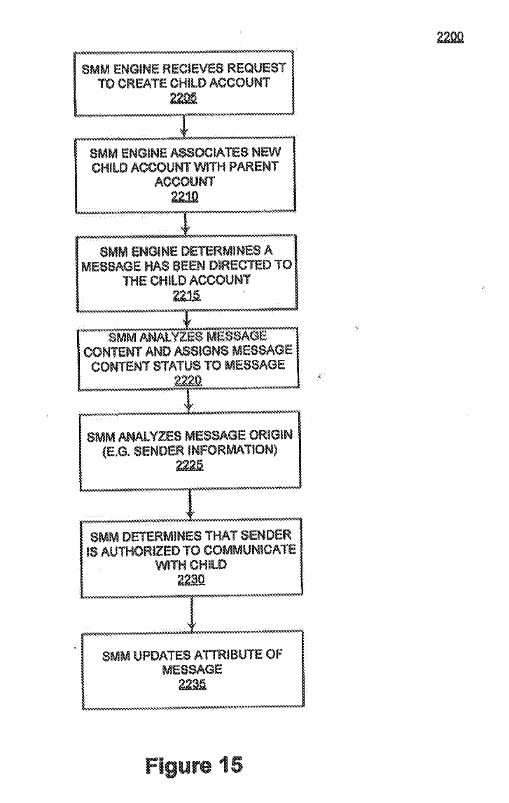

With reference to FIG. 15, in one embodiment, SMM Engine 2147 executes a process to monitor messages sent to or from a user account. As disclosed previously, SMMS 2115 enables analysis, tracking and monitoring of a wide variety of electronic messages. While discussed in terms of text or email messaging for purposes of illustration, one of skill in the art will recognize that the processes disclosed may be used to enable access control, monitoring and tracking of any type of electronic or data message (e.g., text, email, social networking messages or content).

In one embodiment, SMM Engine 2147 receives a request to create a child account (Step 2205). The request may be received from a user interface presented to a user 2105. For instance, user 2105 may be a user registered in SMMS 2115 as a parent and the parent may be setting up an account for a child. SMM Engine 2147 creates the child account and associates the child account with the parent account (Step 2210). In one embodiment, a new account (in this case the child account) is not enabled to receive messages from any email address. In an embodiment, upon creating the child account SMM Engine 2147 may associate the parent account and any other child account of the parent account (i.e., sibling accounts) such that the new child account may receive messages from the parent and the sibling account(s). In one embodiment, CDR 2150 maintains master access lists (e.g., a contact list or an approved list) for each user account to specify messaging accounts that may communicate with a child account.

SMM Engine 2147 determines that a message has been directed to the child account (Step 2215). In an embodiment, CDR 2150 maintains messaging data that is independent of the native messaging format or system. For instance, the access list maintained by CDR 2150 may not be part of an email system and messages received via an email API or other email interface may be processed and/or parsed by SMM Engine 2147 and stored in CDR 2150. SMM Engine 2147 analyzes the message based upon message content rules. Message content may be analyzed by any method known in the art for analyzing data. For instance, text matching, natural language analysis, expert systems, artificial intelligence, image analysis, video analysis, etc. In one embodiment, SMM 2147 invokes a custom computer program configured to analyze images and compute a skin exposure factor. For example, the computer program is configured to identify when a large amount of skin (e.g. over percentage of skin) is displayed and/or when specific body types or body positions are portrayed in an image or video file.

Message content rules may be system or user defined and may exist on CDR 2150 or an external data source. For example, in an embodiment, SMM engine 2147 accesses a dictionary of containing “bad words” that is stored in CDR 2150 and SMM Engine 2147 uses the dictionary, along with message content rules, to determine if the message contains content that is not to be displayed to children. In one embodiment, each parent maintains a separate dictionary of objectionable content that is used to analyze content based upon parent specific sensitivities. Similarly, custom rules may be built based upon any data accessible by the system. For example, a parent may wish to create age brackets for different types of objectionable content (e.g. a five-year old cannot see messages with the word “damn” but a thirteen year-old can).

In an embodiment, objectionable content may contain two or more different levels (e.g. red, yellow, amber) to indicate a relative degree, as determined by the message content analysis, that the content is objectionable. In one embodiment, SMM Engine 2147 is configured to execute rules in a variety of orders or hierarchies. For example, in one embodiment default system rules for analyzing and determining objectionable content may be overridden by the parent and/or community specific rules. Based upon the analysis of the message content, SMM 2147 assigns a message content status to the message (Step 2220). In an embodiment, if the message content status indicates objectionable content, the message is sent automatically to the parent review interface. If the message content status indicates no objectionable content, then processing continues.

SMM 2147 analyzes information regarding the origin of the message (e.g. message sender, domain or IP address from where the message was sent, etc.) (Step 2225). In one embodiment, SMM 2147 evaluates messages based upon the sender's email address or phone number. SMM 2147 accesses a user specific authorized sender list stored in CDR 2150. In one embodiment, only messages from users listed on the authorized list will be made accessible to the child user account. However, in an embodiment, SMM 2147 may be configured to allow messages from everyone except those senders appearing on a prohibited list. For example, SMM 2147 may access an external database of sex offenders and prohibit any messages from senders listed in that database. In an embodiment, other information regarding the sender may be accessed to determine whether a sender should have access to a child. For example, SMM 2147 may be configured to determine whether the sender is already on an approved list for one of the child's siblings.

SMM 2147 determines whether the sender is authorized to communicate with the child account (step 2230). If the sender has not yet been authorized to communicate with the child account then the message is sent to a parent review interface. If the sender has already been identified (e.g., because of a previous message) as a prohibited sender for the child, the message may be deleted and/or archived. In one embodiment, even when a sender has been identified previously as an unauthorized sender, the message may still be directed to a parent interface so that the parent can monitor attempted contact from unauthorized users. In an embodiment, SMM 2147 tracks a variety of statistics regarding messages and provides parents with a large variety of reports to monitor and track messages sent to child accounts.

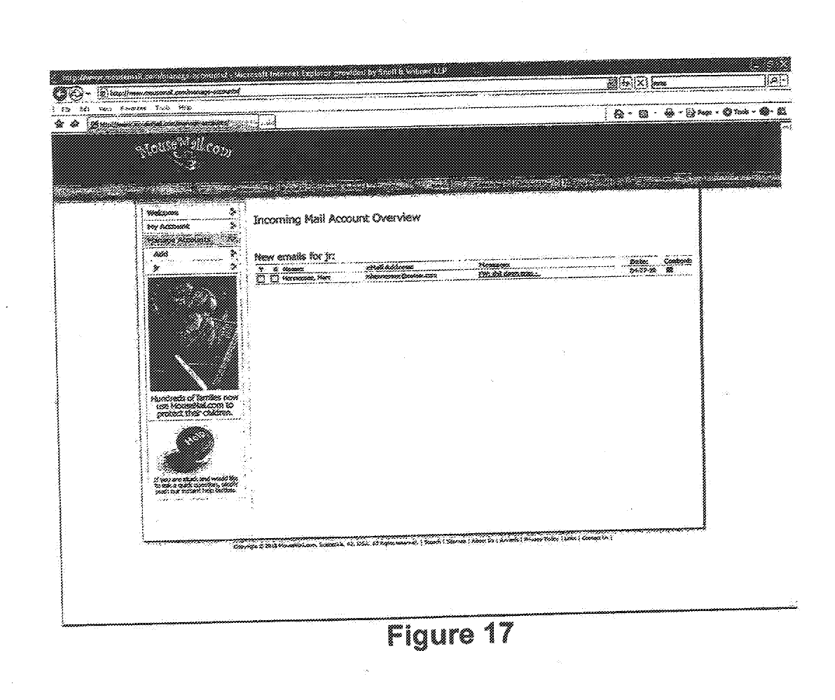

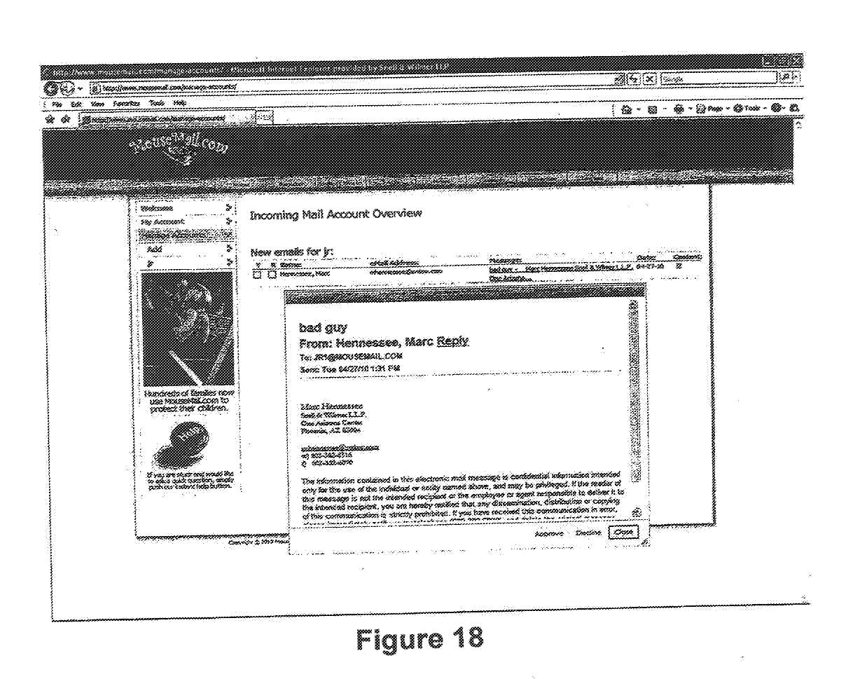

In one embodiment, the parent review interface displays all messages sent to a child account associated with a parent account. The parent review interface enables the parent to review messages that have not been delivered to the child thr at least two possible reasons. First, the content of the message may be objectionable and second the origin of the message is objectionable. For example, FIG. 17 shows one embodiment of a parent review interface. The message shown in FIG. 17 on the parent review interface contains objectionable content. FIG. 18 shows a message that was sent to the parent review interface because the sender was not an approved sender.

The user associated with the parent account (e.g., the child's parent) reviews messages in the parent review interface. The parent review interface allows the parent to view why the message was not delivered by showing, for example, the specific rule or reason, for flagging the message as objectionable. For example, a parent may not realize that a specific word or phrase, which may seem innocuous in the parent's world, has evolved into a word or phrase that in the developing vernacular of children is objectionable. Thus, the parent is not only able to monitor and evaluate messages and determine whether a message should be delivered to the child but also to maintain awareness of potentially alarming aspects of their child's world.

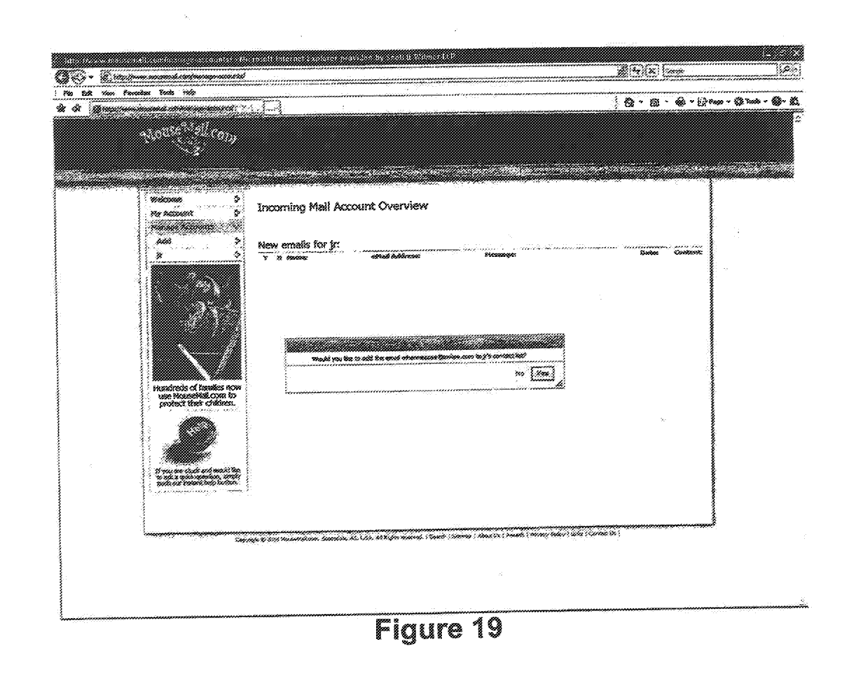

If a parent determines that a sender (e.g., of an email or an SMS message) should be authorized to send messages to the child account, the parent indicates approval, for example, by clicking a checkbox or some other indicator on the parent approval interface. FIG. 19 shows the parent review interface, in this embodiment after the parent has indicated that a sender should be authorized to send the child messages, the parent is presented with the confirmation message. SMM Engine 2147 receives the indication of approval from the parent review interface and updates an attribute of the message to enable the message to be accessed by the child account (Step 2235). In an embodiment, once a sender has been approved to communicate with a child, SMMS 2115 may allow future messages to be received from the sender without parent approval. For instance, SMM 2147 may add the sender to an approved sender list, stored on CDR 2150, for the child. In one embodiment, an approved sender may be approved only for limited time period or may be approved for one type of messaging or content. For example, the parent may allow messages from the sender only during the school year or only until the end of a sports season. Similarly, the parent may approve the child to receive SMS messages from the sender but not MMS messages, or the parent may allow the child to receive email messages from the sender but may not allow the email messages to contain any attachments.

In one embodiment, SMMS 2115 controls and tracks messaging sent from a child account in a manner analogous to that described for receiving messages. For example, CDR 2150 keeps a list of approved recipients to whom the child may send messages. SMM 2147 detects an attempt by the child to send a message and analyzes the message for content and to determine if the recipient is an authorized recipient. The parent approval interface is used by the parent to review requests by the child to send a message and the parent may approve of or deny/restrict content, manually block messages, and approve of or prohibit that the child send messages to a particular recipient.

In an embodiment, a child account is enabled to send messages anonymously. In certain embodiments, the method and systems for anonymous communications set forth in PCT Patent Application Serial No. PCT/US2007/073243 entitled “A Method and System for Anonymous Communication” and this related application's priority applications and related national-stage filings, all of which are herein incorporated by reference in their entirety are used. SMM 2147 provides functionality to “anonymize” outgoing messages so that the sender identity (e.g., name, user id, IP address, etc.) cannot be determined. In an embodiment, SMM 2147 utilizes an external service such as, e.g., http://theanonymousemail.com/. In an embodiment, when a child account chooses to send an email anonymously, the sender and/or the content analysis described above is not performed. For example, if a child is that victim of bullying, the child may be hesitant to report the bully to an authority figure (such as a principal, teacher or parent) if the child worries that his own identity may be compromised. Thus, as defined in configurable rules, SMM 2147 may enable a child to send certain types of emails to certain accounts anonymously.

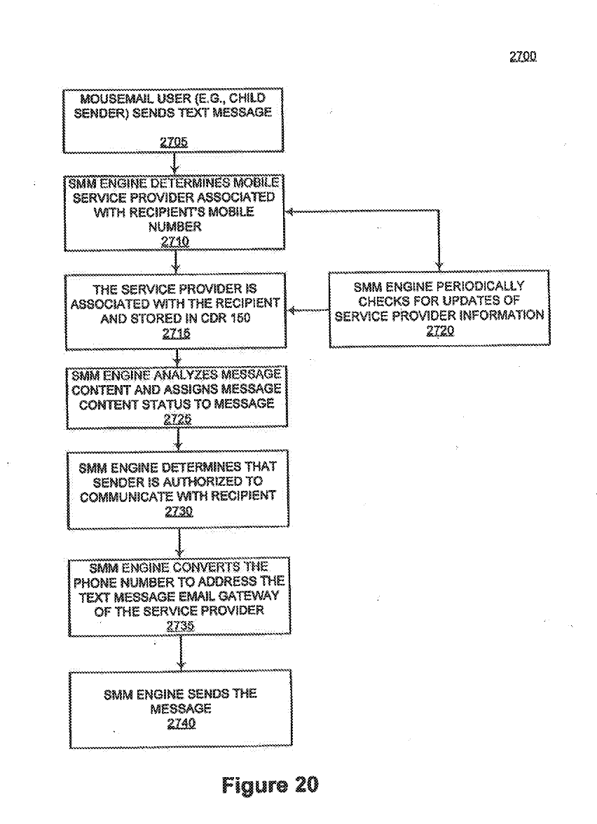

With reference now to FIG. 20, in one embodiment, users access text messaging through the internet on their web enable devices or through a website known as the Mousemail^{SM} website provided by Safe Communications, Inc, of Scottsdale, Ariz. As used herein, these users are described as “Mousemail^{SM} User.”

Sending texts from the Mousemail^{SM} service uses the current service provided by cell phone providers to send text messaging through email. A Mousemail^{SM} User sends a message to a recipient (e.g. by directing it to the recipient's phone number) (Step 2705). SMM Engine 2147 performs a lookup to determine the mobile service provider associated with the recipient's phone number (Step 2710). In an embodiment the lookup is performed to find the mobile service provider and then SMM Engine 2147 associates the correct provider domain name for the message delivery. For example, a Mousemail user sends a text message to (123)555-1212, a lookup is performed on the phone number to find out the provider code associate with it. SMM Engine 147 finds the associated domain (e.g., tmomail.net corresponds to T-Mobile) for the provider code and the message is addressed appropriately (e.g., 1235551212@tmomail.net).

In an embodiment, the lookup is performed by accessing a lookup service provided by telecommunication service providers. In one embodiment, the lookup service queries a home location register (HLR) database. In one embodiment, the HLR Lookup returns a mobile network code (MNC) and a mobile country code (MCC). By having the MCC/MNC information, SIAM Engine 2147 can determine whether the sender has ported their number to a different network compared with the operator prefix (also known as line range) of the number. As one skilled in the relevant art will recognize, MNC is used in combination with MCC (also known as a MCC/MNC tuple) to uniquely identify a mobile phone operator/carrier using the GSM, CDMA, iDEN, TETRA and UMTS public land mobile networks and some satellite mobile networks.

After the lookup is performed the provider for the number is stored in the Mousemail^{SM} website's database for future messaging (Step 2715). In an embodiment, an HLR lookup (i.e. a query of an HLR database) is performed periodically (e.g., daily, weekly, etc.) to insure that the service provider associated with the number has not changed (Step 2720). SMM Engine 2147 analyzes the message content and assigns message content status to message (Step 2725). SMM Engine 2147 determines that sender (e.g., Mousemail^{SM} User) is authorized to communicate with recipient (Step 2730).

If the sender is authorized to communicate with the recipient, SMM Engine 2147 addresses the message by combining the phone number with the service providers email gateway for text message service (Step 2735). For example, a recipient phone number of 1235551212 may be converted to an email address of 1235551212@txt.phoneprovider.com. SMM 2147 sends the message (Step 2740).

Users outside of the Mousemail^{SM} network send text messages to Mousemail^{SM} Users via the Mousemail^{SM} email address. The sender's mobile provider relays the message to Mousemail^{SM} through email. An HLR lookup is performed to obtain the cell provider's ID and associates the sender's email address to that provider id. messages are analyzed for content and for authorized sender similar to the process described in FIG. 15 (i.e., steps 2215-2235). SMM Engine 2147 recognizes the message as a text message and routes the message to the users text messaging inbox which the may access mobile device (e.g., via a web portal or mobile device app).

In an embodiment, the SMMS 2115 serves as a location based services provider. For example, SMMS 2115 is configured with global positioning system (GPS) functionality that enables SMMS 2115 to determine the location of a child's mobile device. Based upon a system or user customized rule (e.g., a rule stored in CDR 2150) SMMS 2115 may determine that the child is in a location (e.g., school, church) where sending and/or receiving messages (e.g. text messages) may be prohibited. SMMS 2115 may store the message and deliver it only when the child moves to an authorized location. Such rules based upon location may be combined in any manner with other rules for delivering or sending messages. For example, SMMS 2115 may generally prohibit messages sent from a child's mobile device that is located at a school but may allow such messages if the messages are being sent to the parent.

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention.

It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements are intended to include any structure, material, or acts for performing the functions in combination with other elements. Reference to an element in the singular is not intended to mean one and only one unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. A system for enabling a safe messaging environment, comprising:
a network interface communicating with a memory;
the memory communicating with a processor;
the processor, when executing a computer program performs operations comprising:
creating, by a processor, a child account associated with a parent account;
receiving, by the processor, a message directed to the child account;
analyzing, by the processor, the message based upon message content rules;
associating, by the processor, a message content status with the message;
determining, by the processor, that the sender of the message is unauthorized to communicate with the child;
redirecting, by the processor, the message to a parent review interface accessible by the parent account, wherein the parent review interface displays the message, the sender and the content status;
receiving, by the processor and from the parent account, an approval allowing the sender to communicate with the child; and,
updating, by the processor, an attribute of the message to enable the message to be accessed by the child account.
